(19) United States
(12) Patent Application Publication
(10) Pub. No.: US 2012/0195823 A1
(43) Pub. Date: Aug. 2, 2012

(54) Novel Hydrogen Storage Materials

(75) Inventors: Hoi Ri Moon, Ulsan (KR); Ki-Joon Jeon, Ulsan (KR); Anne M. Ruminski, El Cerrito, CA (US); Jeffrey J. Urban, Emeryville, CA (US)

(73) Assignee: The Regents of the University of California, Oakland, CA (US)

(21) Appl. No.: 13/361,859

(22) Filed: Jan. 30, 2012

Related U.S. Application Data
(60) Provisional application No. 61/437,456, filed on Jan. 28, 2011.

(51) Int. Cl. C01B 3/56; B01J 20/26; B01J 20/10; B01J 20/02; B82Y 30/00

(52) U.S. Cl. 423/648.1; 252/182.11; 252/182.32; 252/182.33; 524/560; 524/588; 524/609; 524/80; 977/773; 977/902; 977/762; 977/810

(57) ABSTRACT

The present invention provides for a composition capable of storing hydrogen from molecular hydrogen. The composition comprises a magnesium nanoparticle (NP) and a polymer, wherein the Mg NC is essentially embedded in the polymer. The polymer is selectively permeable wherein the polymer is essentially not permeable to O₂ and H₂O. The composition is capable of absorbing and desorbing molecular hydrogen.

### RELATED PATENT APPLICATIONS

This application claims priority to U.S. Provisional Patent Application Ser. No. 61/437,456, filed Jan. 28, 2011, which are hereby incorporated by reference in its entirety.

### STATEMENT OF GOVERNMENTAL SUPPORT

This invention was made with government support under Contract No. DE-AC02-05CH11231 awarded by the U.S. Department of Energy. The government has certain rights in the invention.

### FIELD OF THE INVENTION

This invention relates generally to hydrogen storage materials.

### BACKGROUND OF THE INVENTION

Hydrogen is a promising alternative energy carrier that can potentially facilitate the transition from fossil fuels to sources of clean energy due to its prominent advantages such as high energy density (142 MJ/kg)¹, great variety of potential sources (e.g. water, biomass, organic matter), light weight, and low environmental impact (water is the sole combustion product). However, there remains a challenge to produce a material capable of simultaneously optimizing two conflicting criteria—absorbing hydrogen strongly enough to form a stable thermodynamic state, but weakly enough to release it on-demand with a small temperature rise. Many materials under development, including metal-organic frameworks,² nanoporous polymers,³ and other carbon-based materials,⁴ physisorb only a small amount of hydrogen (typically 1-2 wt. %) at room temperature. Metal hydrides were traditionally thought to be unsuitable materials due to their high bond formation enthalpies (e.g. MgH₂ has a ΔHf˜75 kJ/mol), thus requiring unacceptably high release temperatures⁵ resulting in low energy efficiency. However, recent theoretical calculations^{6,7} and metal-catalyzed thin film studies⁸ have shown that microstructuring of these materials can enhance the kinetics by decreasing diffusion path lengths for hydrogen and decreasing the required thickness of the poorly permeable hydride layer that forms during absorption.

### SUMMARY OF THE INVENTION

The present invention provides for a composition capable of storing hydrogen from molecular hydrogen. The composition comprises a nanoparticle (NP) and a polymer, wherein the NP is essentially embedded in the polymer. The polymer is selectively permeable wherein the polymer is essentially not permeable to O₂ and H₂O. The composition is capable of absorbing and desorbing molecular hydrogen. Molecular hydrogen is H₂.

The present invention also provides for a method of producing a composition capable of storing hydrogen from molecular hydrogen. In some embodiments of the invention, the method comprises the method described in Example 1 herein.

The present invention also provides for a method of storing hydrogen comprising: (a) providing the composition of the present invention, (b) contacting a molecular hydrogen with the composition, and (c) increasing the temperature of the composition such that the molecular hydrogen is separates from the composition.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 shows: (a) Schematic of hydrogen storage composite material: high-capacity Mg NCs are encapsulated by a selectively gas-permeable polymer. (b) Synthetic approach to formation of Mg NCs-PMMA nanocomposites.

FIG. 2 shows verification of single crystalline Mg nanoparticles: (a) High resolution TEM micrograph of as-synthesized Mg NCs/PMMA composites. Inset: Histogram and cumulative distribution function of Mg particle size distributions. The average Mg NC diameter is 4.9±2.1 nm. (b) Atomic-resolution image of a single Mg NC. (c) Digital diffractogram of the Mg NC in (B), revealing that the product is single-phase hexagonal magnesium. (d) X-ray diffraction patterns of Mg NC/PMMA composites: as-synthesized (top), and after 3 days of air-exposure (middle) with reference diffraction patterns (bottom) of hexagonal Mg (solid black line, JCPDS 04-0770), cubic MgO (long dashed grey line, JCPDS 89-7746), and hexagonal Mg(OH)₂ (short dashed grey line, JCPDS 07-0239). Peaks located at 2θ=32.2, 34.4, 36.6, 47.8, 57.4 and 63.1 are assigned to the (100), (002), (101), (102), (110), and (103) planes of hexagonal magnesium, respectively. The highest intensity Mg(OH), peak after 3 days of air exposure, occurring at 2θ=58.6 (110), is 1/30th the intensity of the most intense Mg peak (101), and only 2 times the intensity of the root-mean-squared baseline noise intensity.

FIG. 3 shows hydrogen absorption in Mg NCs/PMMA composites: (a) Enhancement in hydrogen absorption properties of Mg NCs/PMMA composites (absorption at 200° C. and 35 bar) in comparison to bulk Mg. The Mg NCs/PMMA composites display a calculated hydrogen absorption capacity value of 5.97 wt. % Mg (˜4 wt. % total). Inset: hydrogen cycling at 200° C. (b) The initial growth mechanism of MgH₂ in Mg NCs/PMMA composites. Hydrogen absorption data shown in A (initial 6 minutes) was used to correlate with a Johnson-Mehl-Avrami model (eq. 1).

FIG. 4 shows time resolved monitoring of hydrogen desorption from MgH₂ NCs/PMMA composites. Low-loss EELS spectra of MgH₂ NCs/PMMA using TEAM 0.5 microscope at 80 kV. Mg plasmon energy loss: 10.5 eV, and MgH₂ plasmon energy loss: 14.6 eV. All spectra were normalized to the Mg peak position at 10.5 eV. Note that peaks occurring at a constant interval of ˜10.3 eV (located at 21.0 eV and 31.3 eV) are Mg plasmon replica.

FIG. 5 shows TEM analysis of reaction mixture a.) before addition of reductant, b.) immediately thereafter, c.) 20 minutes after addition of reductant (d_{avg}=3.56±0.59 nm), and d.) after a standard 20 h growth period (d_{avg}=4.59±1.04 nm). Histograms of the magnesium nanocrystal sizes are also shown for the e.) 20 minute and f.) 20 hour reaction times. These data support the burst-nucleation model described herein.

FIG. 6 shows a histogram of the diameters of the magnesium nanocrystals present in the nanocomposite materials as measured by HRTEM. Sizes were recorded on over a dozen samples from independent syntheses.

FIG. 7 shows additional TEM images of Mg NCs/PMMA composite samples from independent syntheses.

FIG. 8 shows X-ray diffraction pattern (top) of as-synthesized Mg NCs/hexadecylamine composite with references (bottom) of hexagonal Mg (solid black line, JCPDS 04-0770), cubic MgO (long dashed grey line, JCPDS 89-7746) and hexagonal Mg(OH)₂ (short dashed light grey line, JCPDS 07-0239). Mg NCs composites formed with hexadecylamine encapsulation showed evidence of immediate oxidation of the Mg NCs to Mg(OH)₂ and trace MgO.

FIG. 9 shows a typical thermogravimetric analysis (TGA) and differential scanning calorimetry (DSC) traces of Mg NCs/PMMA composites, red solid line and dashed line, respectively. TGA trace of pure PMMA is shown as a control (black solid line). The Mg NCs/PMMA composite TGA trace displayed two distinct slopes: the first weight loss from room temperature to 250° C. is attributed to the evaporation of residual solvent and the removal of low molecular weight polymers, while the second weight loss which plateaus around 500° C. is attributed to the degradation of the PMMA polymer matrix. In the pure PMMA TGA trace, weight loss was complete at ˜440° C. when all of the polymer has been burned off, which corresponds closely with the TGA data obtained on the Mg-PMMA composites. The remaining weight in TGA of the Mg NCs/PMMA composites is thereby attributed to the pure Mg metal. Based upon this value, it is concluded that the weight of the hydrogen storage active material (pure Mg) in the Mg NCs/PMMA composites is 61% of the total nanocomposite weight.

FIG. 10 shows low loss electron energy loss spectrum (EELS) of a 50 nm MgO powder at 80 kV under TEAM 0.5 (at 80 kV). MgO was stable during the 10 minutes of beam exposure, with the largest MgO plasmon energy loss occurring at 22.3 eV. The overall spectrum shape is consistent with N. Jiang, D. Su, J. C. H. Spence, A. Howie, Appl. Phys. Lett. 94, 253105 (2009).

FIG. 11 shows the determination of activation energy for a.) absorption and b.) desorption of hydrogen in Mg NC/PMMA nanocomposites. Hydrogen absorption and desorption was measured at three different temperatures (T=473, 523, and 573 K) and the activation energies were determined by plotting the log of the rate constant versus 1/T.

FIG. 12 shows kinetic models of hydride formation in the Mg NC/PMMA nanocomposite: (a) chemisorption, (b) 2-dimensional growth, (c) 3-dimensional growth, and (d) coreshell growth. The large black circles represent the resulting curves of different kinetic equations applied to the experimental hydrogen uptake data of Mg NCs/PMMA composites (initial 6 minutes); the linear fit R² value is listed below. The small black circles represent a linear fit to the data. Insets: MgH₂ growth schematics.

### DETAILED DESCRIPTION

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a diacid” includes a plurality of such diacids, and so forth.

These and other objects, advantages, and features of the invention will become apparent to those persons skilled in the art upon reading the details of the invention as more fully described below.

The present invention provides for a composition capable of storing hydrogen from molecular hydrogen. The composition comprises a suitable metallic nanoparticle (NP), such a magnesium or titanium NP, and a polymer, wherein the NP is essentially embedded in the polymer. The polymer is selectively permeable wherein the polymer is essentially not permeable to O₂ and H₂O. The composition is capable of absorbing and desorbing molecular hydrogen. Molecular hydrogen is H₂. In some embodiments, the NP content is equal to or greater than about 20 wt. %, 40 wt. %, 60 wt. %, or 80 wt. % of the composition.

In some embodiments of the invention, the NP is Mg NP and Mg is essentially a single-phase hexagonal Mg. In some embodiments of the invention, the NP is Ti NP. In some embodiments of the invention, the NP is a nanocrystal (NC), nanotube, nanorod, nanowire, or the like. In some embodiments of the invention, the Mg NP is a Mg NC.

In some embodiments of the invention, the size of the NP is from about 1 nm to about 10 nm in diameter for the longest or shortest linear dimension. In some embodiments of the invention, the size of the NP is from about 2.8 nm or 3 nm to about 7 nm in diameter for the longest or shortest linear dimension. In some embodiments, the size of the NP is from about 4 nm to about 6 nm in diameter for the longest or shortest linear dimension.

In some embodiments of the invention, the average size of the NP is from about 1 nm to about 10 nm in diameter for the longest or shortest linear dimension. In some embodiments of the invention, the average size of the NP is from about 2.8 nm or 3 nm to about 7 nm in diameter for the longest or shortest linear dimension. In some embodiments, the average size of the NP is from about 4 nm to about 6 nm in diameter for the longest or shortest linear dimension.

In some embodiments of the invention, when the NP is a nanotube, nanorod, or nanowire, the diameter of the cross-section of the NP is from about 1 nm to about 10 nm. In some embodiments of the invention, when the NP is a nanotube, nanorod, or nanowire, the diameter of the cross-section of the NP is from about 2.8 nm or 3 nm to about 7 nm. In some embodiments of the invention, when the NP is a nanotube, nanorod, or nanowire, the diameter of the cross-section of the NP is from about 4 nm to about 6 nm.

In some embodiments of the invention, when the NP is a nanotube, nanorod, or nanowire, the average diameter of the cross-section of the NP is from about 1 nm to about 10 nm. In some embodiments of the invention, when the NP is a nanotube, nanorod, or nanowire, the average diameter of the cross-section of the NP is from about 2.8 nm or 3 nm to about 7 nm. In some embodiments of the invention, when the NP is a nanotube, nanorod, or nanowire, the average diameter of the cross-section of the NP is from about 4 nm to about 6 nm.

In some embodiments of the invention, the longest or shortest linear dimension, or diameter of the cross-section, or average thereof, of the NP is equal to or less than 10 nm, 9 nm, 8 nm, 7 nm, 6 nm, or 5 nm.

In some embodiments of the invention, the NP can be Mg NP or Ti NP. Both Mg and Ti can be catalysts of the present invention.

The polymer is any suitable polymer that is essentially not permeable to both O₂ and H₂O. In some embodiments of the invention, the polymer has a ratio of permeability for H₂ to permeability for O₂ of equal to or higher than 5. In some embodiments of the invention, the polymer has a ratio of permeability for H₂ to permeability for O₂ of equal to or higher than 10. In some embodiments of the invention, the polymer has a ratio of permeability for H₂ to permeability for O₂ of equal to or higher than 20. In some embodiments of the invention, the polymer has a ratio of permeability for H₂ to permeability for O₂ of equal to or higher than 30. In some embodiments of the invention, the polymer has a ratio of permeability for H₂ to permeability for O₂ of equal to or higher than 40. In some embodiments, the polymer is at least sufficiently flexibility to be capable of withstanding volume expansion, such as up to about 33% or at least about 33%. The transition of Mg to MgH₂ causes a volume expansion.

In some embodiments of the invention, the polymer is a polyacrylate, silicone, glass, or sulfonate. In some embodiments of the invention, the polymer is a poly(alkyl methacrylate). In some embodiments of the invention, the polymer is a poly(methyl methacrylate) (PMMA) or poly(methyl acrylate) (PMA).

In one embodiment of the invention, the composition comprises a Mg NP-PMMA or a Ti NP-PMMA composite.

In some embodiment of the invention, the composition is capable of absorbing equal to or more than about 4 wt. % of molecular hydrogen. In some embodiment of the invention, the composition is capable of absorbing equal to or more than about 5 wt. % of molecular hydrogen. In some embodiment of the invention, the composition is capable of absorbing equal to or more than about 6 wt. % of molecular hydrogen.

In some embodiment of the invention, the composition is capable of separating any or essentially all absorbed molecular hydrogen when the temperature of the composition is equal to or more than about 200° C.

The present invention also provides for a method of producing a composition capable of storing hydrogen from molecular hydrogen. In some embodiments, the method comprises: (a) providing a reaction solution comprising (i) an organometallic precursor, such as bis(cyclopentadienyl)magnesium (Cp₂Mg) or bis(cyclopentadienyl)titanium, (ii) a reducing agent, such as lithium naphthalide, and (iii) a gas-selective polymer, such as poly(methyl methacrylate) (PMMA), polystyrene (PS), polyethylene (PE), or poly (lactic acid) (PLA), dissolved in a suitable organic solvent, such as tetrahydrofuran; and (b) growing metallic nanocrystals from the organometallic precursor. The gas-selective polymer is soluble and is selected for its hydrogen gas selectivity, such as a hydrogen gas selectivity equal to or better than about that of PMMA. The reducing agent is capable of reducing the organometallic precursor in the presence of a capping ligand. In some embodiments, the capping ligand is the gas-selective polymer. In some embodiments, the capping ligand is a compound different from the gas-selective polymer, and the reaction solution further comprises a capping ligand. In some embodiments, the growing step comprises a burst-nucleation and growth mechanism. The reaction mixture can performed at any suitable temperature, such as at about room temperature.

In some embodiments of the invention, the method comprises the method described in Example 1 herein.

The present invention also provides for a method of storing hydrogen comprising: (a) providing the composition of the present invention, (b) contacting a molecular hydrogen with the composition, and (c) increasing the temperature of the composition such that the molecular hydrogen is separates from the composition.

The present invention also provides for a composite of air-stable Mg NP and gas-selective polymer for hydrogen storage. Mg is one of the most promising inorganic materials for hydrogen storage. Specifically the corresponding hydride, MgH₂, exhibits high hydrogen capacity (7.6 wt %). In the present invention, synthetic methodology for metallic Mg NP I solution phase is developed. Nanoscale metallic Mg has a high surface area, short diffusion lengths for hydrogen and reduced enthalpy barriers toward hydrogen molecules. The present invention also provides for a composite of air-stable Ti NP and gas-selective polymer for hydrogen storage. Further, composite materials which embed Mg NP, Mg NC, Ti Np, or Ti NC into a polymer, such as an organic polymer, with selective gas permeability. This provides a route to solve the predictable problems related to nanostructures such as poor cyclability and degradation of the sorption properties due to deformation and oxidation.

The composition can be used in any device that stores hydrogen and/or utilizes hydrogen for buoyancy or as a fuel. A device that utilizes hydrogen as fuel is a car that comprises an engine that runs on hydrogen.

### REFERENCES CITED

1 Jain, I. P., Lal, C. & Jain, A. Hydrogen storage in Mg: A most promising material. Int. J. Hydrog. Energy 35, 5133-5144 (2010).
2 Murray, L. J., Dinca, M. & Long, J. R. Hydrogen storage in metal-organic frameworks. Chem. Soc. Rev. 38, 1294-1314 (2009).
3 Germain, J., Frechet, J. M. J. & Svec, F. Nanoporous polymers for hydrogen storage. Small 5, 1098-1111 (2009).
4 Patchkovskii, S. et al. Graphene nanostructures as tunable storage media for molecular hydrogen. Proc. Natl. Acad. Sci. U.S.A. 102, 10439-10444 (2005).
5 Schlapbach, L. & Zuttel, A. Hydrogen-storage materials for mobile applications. Nature 414, 353-358 (2001).
6 Cheung, S., Deng, W.-Q., van Duin, A. C. T. & Goddard, W. A. ReaxFFMgH reactive force field for magnesium hydride systems. J. Phys. Chem. A. 109, 851-859 (2005).
7 Wagemans, R. W. P., van Lenthe, J. H., de Jongh, P. E., van Dillen, A. J. & de Jong, K. P. Hydrogen storage in magnesium clusters: quantum chemical study. J. Am. Chem. Soc. 127, 16675-16680 (2005).
8 Zahiri, B., Amirkhiz, B. S. & Mitlin, D. Hydrogen storage cycling of MgH₂ thin film nanocomposites catalyzed by bimetallic Cr Ti. Appl. Phys. Lett. 97, 083106 (2010).
9 Aguey-Zinsou, K. F., Ares Fernandez, J. R., Klassen, T. & Bormann, R. Effect of Nb2O₅ on MgH₂ properties during mechanical milling. Int. J. Hydrog. Energy 32, 2400-2407 (2007).
10 Haas, I. & Gedanken, A. Synthesis of metallic magnesium nanoparticles by sonoelectrochemistry. Chem. Commun., 1795-1797 (2008).
11 Li, W., Li, C., Ma, H. & Chen, J. Magnesium nanowires: enhanced kinetics for hydrogen absorption and desorption. J. Am. Chem. Soc. 129, 6710-6711 (2007).
12 de Jongh, P. E. et al. The preparation of carbon-supported magnesium nanoparticles using melt infiltration. Chem. Mater. 19, 6052-6057 (2007).
13 Park, J., Joo, J., Kwon, S. G., Jong, Y. & Hyeon, T. Synthesis of monodisperse spherical nanocrystals. Angew. Chem. Int. Ed. 46, 4630-4660 (2007).
14 Grubbs, R. B. Roles of polymer ligands in nanoparticle stabilization. Polym. Rev. 47, 197-215 (2007).
15 Kalidindi, S. B. & Jagirdar, B. R. Highly monodisperse colloidal magnesium nanoparticles by room temperature digestive ripening. Inorg. Chem. 48, 4524-4529 (2009).
16 Polymer Data Handbook. (Oxford University Press, 1999).
17 Min, K. E. & Paul, D. R. Effect of tacticity on permeation properties of poly(methyl methacrylate). J. Polym. Sci. Polym. Phys. 26, 1021-1033 (1988).
18 Bhide, B. D. & Stem, S. A. Permeability of silicone polymers to hydrogen. J. Appl. Polym. Sci. 42, 2397-2403 (1991).
19 Zlotea, C., Lu, J. & Andersson, Y. Formation of one-dimensional MgH₂ nanostructures by hydrogen induced disproportionation. J. Alloy. Compd. 426, 357-362 (2006).
20 Moon, H. R., Urban, J. J. & Milliron, D. J. Size-controlled synthesis and optical properties of monodisperse colloidal magnesium oxide nanocrystals. Angew. Chem. Int. Ed. 48, 6278-6281 (2009).
21 Rudman, P. S. Hydrogen-diffusion-rate-limited hydriding and dehydriding kinetics. J. Appl. Phys. 50, 7195-7199 (1979).
22 Vigeholm, B., Kjoller, J. & Larsen, B. Magnesium for hydrogen storage. J. Less Common Met. 74, 341-350 (1980).
23 Kisielowski, C. et al. Detection of single atoms and buried defects in three dimensions by aberration-corrected electron microscope with 0.5-Å information limit. Microsc. Microanal. 14, 469-477 (2008).
24 Danaie, M., Tao, S. X., Kalisvaart, P. & Mitlin, D. Analysis of deformation twins and the partially dehydrogenated microstructure in nanocrystalline magnesium hydride (MgH₂) powder. Acta Mater. 58, 3162-3172 (2010).
25 Dornheim, M., Eigen, N., Barkhordarian, G., Klassen, T. & Bormann, R. Tailoring hydrogen storage materials towards application. Adv. Eng. Mater. 8, 377-385 (2006).
26 Denis, A., Sellier, E., Aymonier, C. & Bobet, J. L. Hydrogen sorption properties of magnesium particles decorated with metallic nanoparticles as catalyst. J. Alloy. Compd. 476, 152-159 (2009).
27 Avrami, M. Granulation, phase change, and microstructure-kinetics of phase change. III. J. Phys. Chem. 9, 177-184 (1941).
28 Christian, J. W., The theory of transformations in metals and alloys, Part I: Equilibrium and General Kinetic Theory, 2nd ed. (Pergamon Press, Oxford, 1975).
29 Ragone, D. V., Thermodynamics of materials. (Wiley, New York, 1995).

The invention having been described, the following examples are offered to illustrate the subject invention by way of illustration, not by way of limitation.

### Example 1

Here, we report the synthesis of an air-stable composite material comprised of metallic Mg nanocrystals (NCs) in a gas-barrier polymer matrix that enables both the storage of a high density of hydrogen (up to 6 wt. % of Mg, 4 wt % for the composite) and rapid kinetics (loading in <30 mins. at 200° C.). Moreover, nanostructuring of the Mg provides rapid storage kinetics without heavy, expensive metal catalysts.

The Mg NCs/PMMA composites are prepared in an inert atmosphere. Bis(cyclopentadienyl)magnesium (Cp₂Mg) (154 mg, 1.00 mol) is reduced in a solution of tetrahydrofuran (9 mL) containing lithium (9 mg, 12.9 mmol), naphthalene (120 mg, 9.4 mmol), and poly(methyl methacrylate) (60 mg), stirring under a nitrogen atmosphere overnight. The resultant product is isolated by centrifugation, washed with tetrahydrofuran, and dried under an inert atmosphere prior to performing all characterization and measurements. The hydrogenation experiments are performed on the composite samples after first annealing in a Helium environment for ≧24 hrs to remove solvent and unreacted monomer. The hydrogenation/desorption tests are performed at 200° C. and 35 and 0 bar of H₂ respectively.

### General Methods

Poly(methyl methacrylate) (PMMA, MW=120 000, Aldrich), naphthalene (Aldrich), and 1-hexadecylamine (90%, technical grade, Aldrich) are dried completely under high vacuum, and tetrahydrofuran is freshly distilled immediately before use. High purity Li metal foils (Cyprus. USA) are used as received. Bulk Mg (44 μm) and MgO (50 nm) are purchased from Alfa Aesar and Aldrich, respectively. All synthetic procedures are performed in an inert atmosphere glove box.

### Preparation of Lithium Naphthalide Stock Solution

Lithium naphthalide stock solution is prepared as described in H.-J. Liu, J. Yip, K.-S. Sia, Tetrahedron Lett. 38, 2253 (1997). Naphthalene (0.12 g, 9.4 mmol) is dissolved in 6 mL of tetrahydrofuran, followed by the addition of Li metal (9 mg, 12.9 mmol) at room temperature under inert atmosphere. This mixture is stirred until the lithium is completely dissolved. As lithium metal dissolves, the color of the solution changes from colorless to dark green as lithium napthalide forms. It is imperative to use this solution within 30 minutes of mixing.

### Preparation of Mg NCs/PMMA Composites

Poly(methyl methacrylate) (60 mg) is mixed in tetrahydrofuran (3 mL) by stirring magnetically at room temperature under nitrogen atmosphere overnight. Bis(cyclopentadienyl)magnesium (CP₂Mg) (154 mg, 1.00 mmol) is added and the solution is stirred until completely dissolved (30 minutes), producing a pale yellow mixture. Next, the 3 mL PMMA/CP₂Mg solution is added to the 6 mL lithium naphthalide stock solution, becoming turbid within minutes to yield dark grey flocculate. The reaction mixture is magnetically stirred overnight. The resultant product is separated from the solution by centrifugation (9000 rpm, 20 min) and the resulting pellet is washed with THF (in the glovebox) and further centrifuged to remove residual PMMA. Samples are allowed to completely dry in the inert atmosphere glovebox before exposure to ambient atmosphere.

### Characterization

X-ray diffraction (XRD) patterns are obtained using a Bruker D8 Discover X-ray diffractometer with a general area detector diffraction system (GADDS) using Cu Kα radiation (λ=0.154 nm). The size and morphology of polymer matrix embedded Mg NCs are analyzed by transmission electron microscopy (Philips CM200 FEG, 200 kV accelerating voltage). Real time EELS is performed by a transmission electron aberration-corrected microscope (TEAM 0.5 80 kV accelerating voltage). Thermogravimetric analysis (TGA) and differential scanning calorimetry (DSC) are performed under N₂(g) at a scan rate of 5° C./min in TG/DSC instrument (Netzsch STA449 F3).

### Hydrogen Uptake and Release Study

Mg NCs/PMMA composites (170 mg, stored in Ar) are loaded into a hydrogenation chamber (PCT Pro-2000, Hy-Energy) in an air environment. Prior to performing hydrogenation experiments, Mg NCs/PMMA composites are annealed at 200° C. in a He environment for 1 day to remove residual solvent and low density PMMA. Next, all gases are removed by heating samples under vacuum at 70° C. The sample is then cooled down to room temperature. The hydrogenation/desorption tests are performed at 200° C. and 35 and 0 bar of H₂ respectively. The same experimental procedure is repeated exactly for bulk Mg (44 μm) except that it is handled in an Ar environment and never exposed to air.

### Results and Discussion

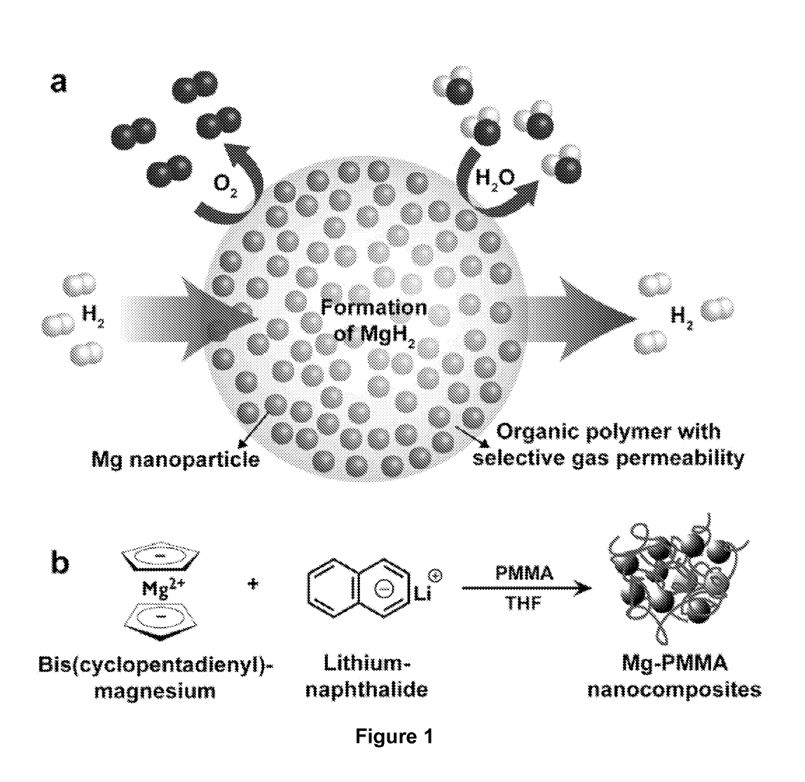

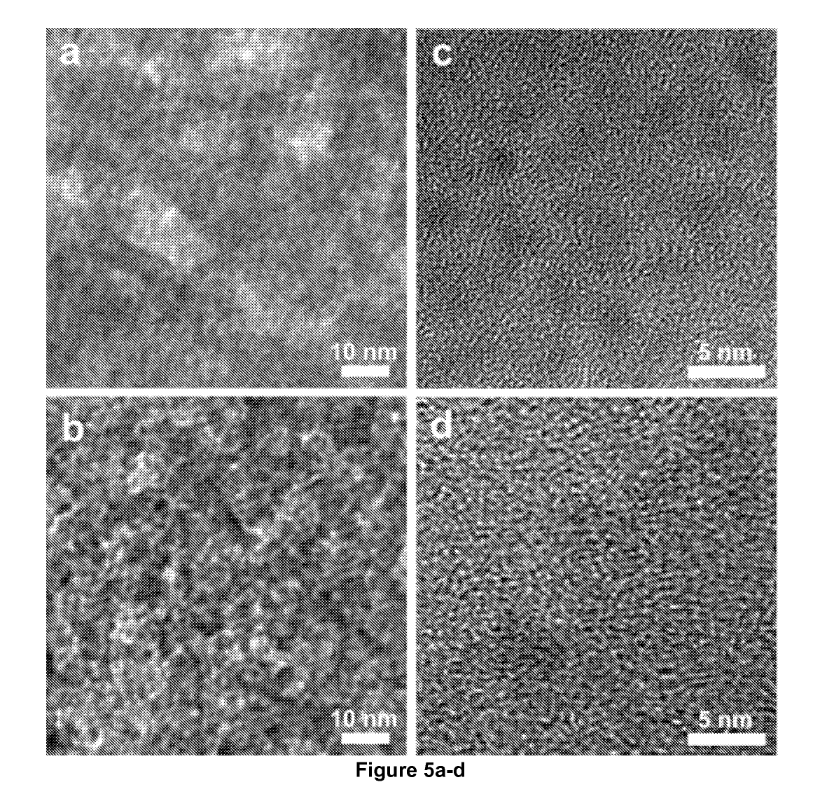

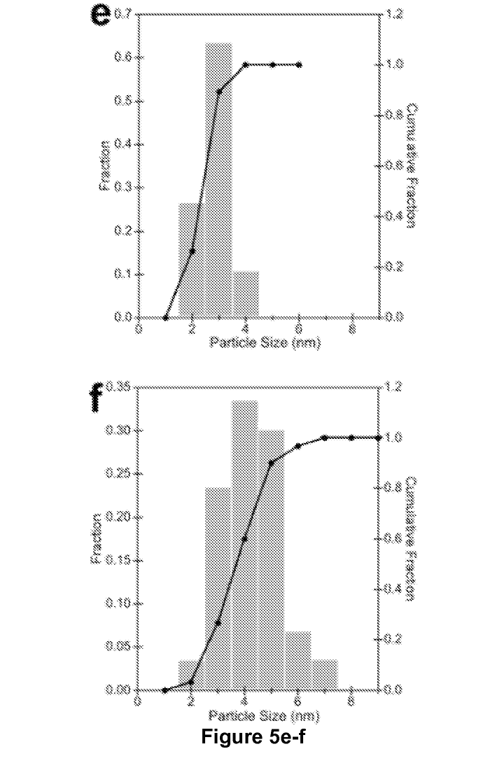

There have been various efforts to synthesize nanosized magnesium, such as ballmilling,⁹ sonoelectrochemistry,¹⁰ gas-phase condensation,¹¹ and infiltration of nanoporous carbon with molten magnesium.¹² However, these approaches remain limited by inhomogeneous size distributions and high reactivity toward oxygen. Our synthesis for airstable alkaline earth metal NC/polymer composites consists of a one-pot reduction reaction of an organometallic Mg²⁺ precursor in the presence of a soluble organic polymer chosen for its hydrogen gas selectivity (FIG. 1). The Mg NC/PMMA nanocomposites were synthesized at room temperature from a homogeneous tetrahydrofuran solution containing the following dissolved components: the organometallic precursor bis(cyclopentadienyl)magnesium (Cp₂Mg), the reducing agent lithium naphthalide, and the gas-selective polymer poly(methyl methacrylate) (PMMA). Mg nanocrystals are then nucleated and grown in this solution via a burst-nucleation and growth mechanism¹³ in which lithium napthalide reduces the organometallic precursor in the presence of a capping ligand (the soluble PMMA (Mw=120,000) acts as a capping ligand for the Mg nanocrystals).¹⁴ TEM analysis of our reaction mixture before addition of reductant, immediately thereafter, and at later stages of the growth (FIG. 5) further support this model. This synthesis provides a gas-selective polymer barrier for the Mg NCs, which enables them to absorb and release hydrogen without oxidizing. This is vital, as magnesium metal exothermically (−601.24 kJ/mol) forms oxides upon exposure to even minute quantities of air or water, resulting in MgO and Mg(OH)₂ layers which, in addition to not absorbing hydrogen, also actively block penetration of H₂ molecules and H atoms. Thus oxidation deleteriously creates “dead” layers, inactive as storage media. While nanocrystals potentially provide a route to boosting the kinetics of hydrogenation in metallic Mg due to intrinsically short diffusion paths for hydrogen, no methods have yet been demonstrated to effectively protect even ligand-passivated Mg NCs from oxidation.¹⁵ For our composites, we chose the polymer, poly(methyl methacrylate) (PMMA),¹⁶ which shows the ability to mitigate oxygen penetration and damage, with permeabilities for H₂ and O₂ of 1.15 and 0.0269×10⁵ mol Pa⁻¹ s⁻¹ (3.70 and

$$0.0863 \times {10}^{10} \frac{{cm}^{3} ( S T P ) * cm}{{cm}^{2} * s * cmHg} ,$$

respectively,¹⁷ resulting in a H₂/O₂ permeability ratio of 42.9 at 35° C., far exceeding that of other commonly available polymers (for example, 1.03 at 35° C. and 8.57 at 25° C. for poly(dimethylsiloxane) and polycarbonate, respectively).¹⁶⁻¹⁸ Additionally, it is critical to have a mechanically flexible polymer, both to optimize volumetric storage capacity by eliminating “dead space” as well as providing an accommodating support for the large volume expansion (33% for the Mg to MgH₂ transition) that metals undergo during absorption cycling.¹⁹

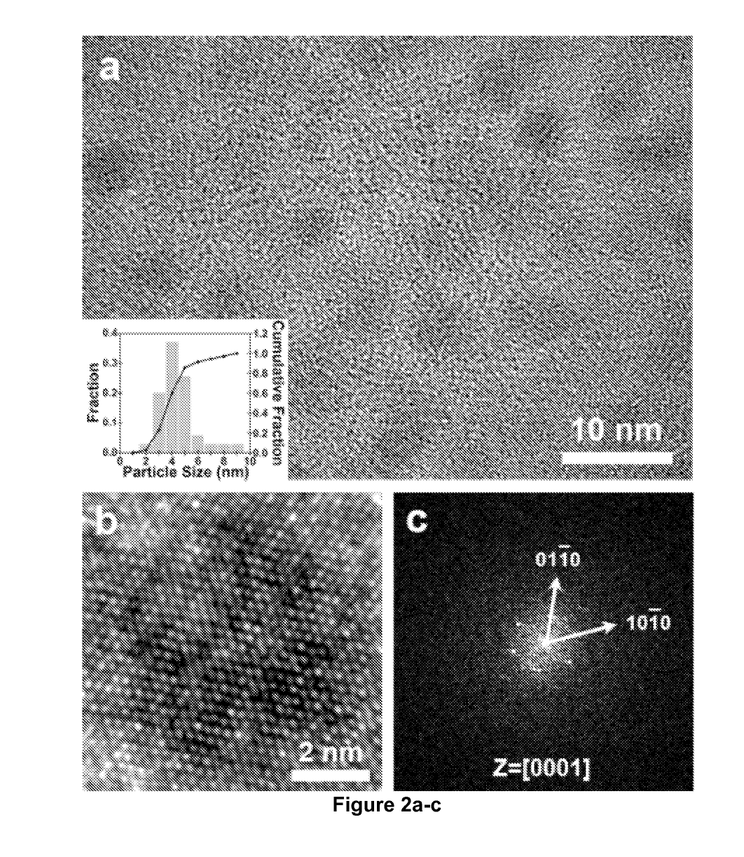

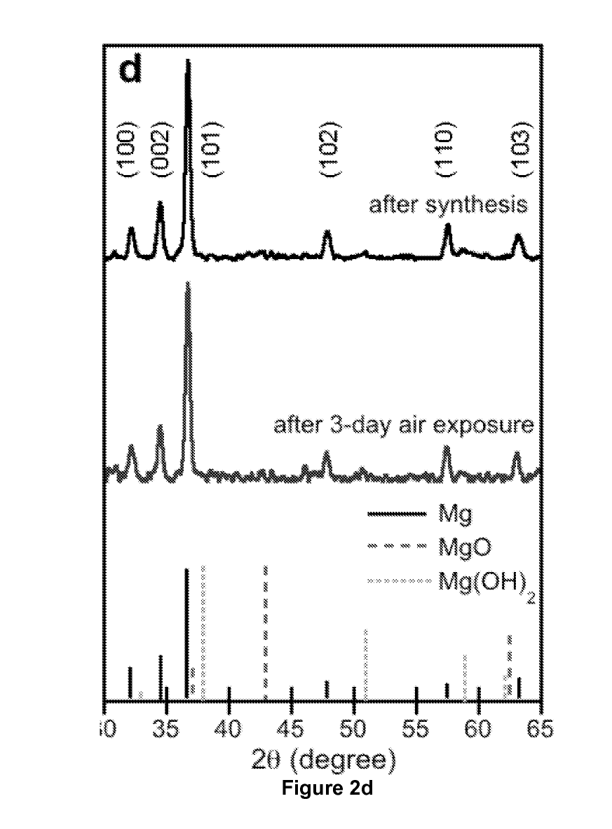

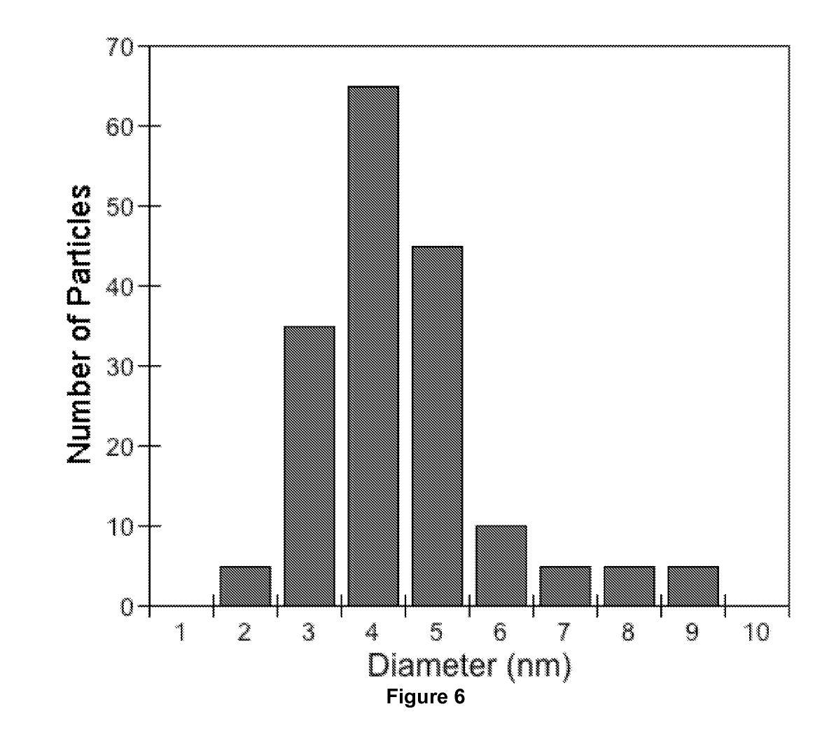

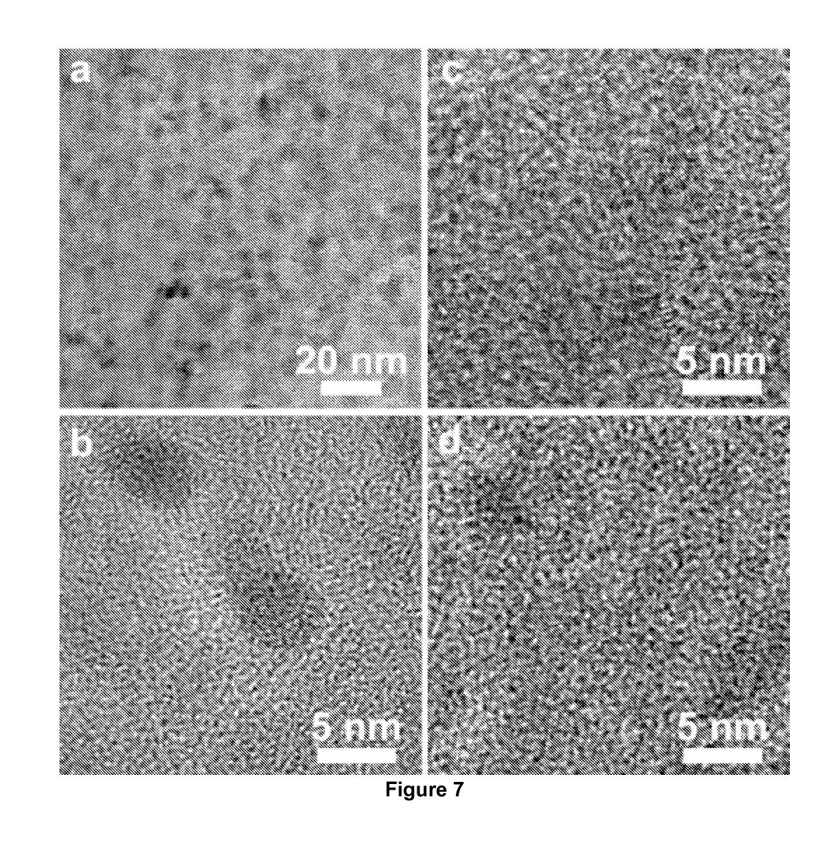

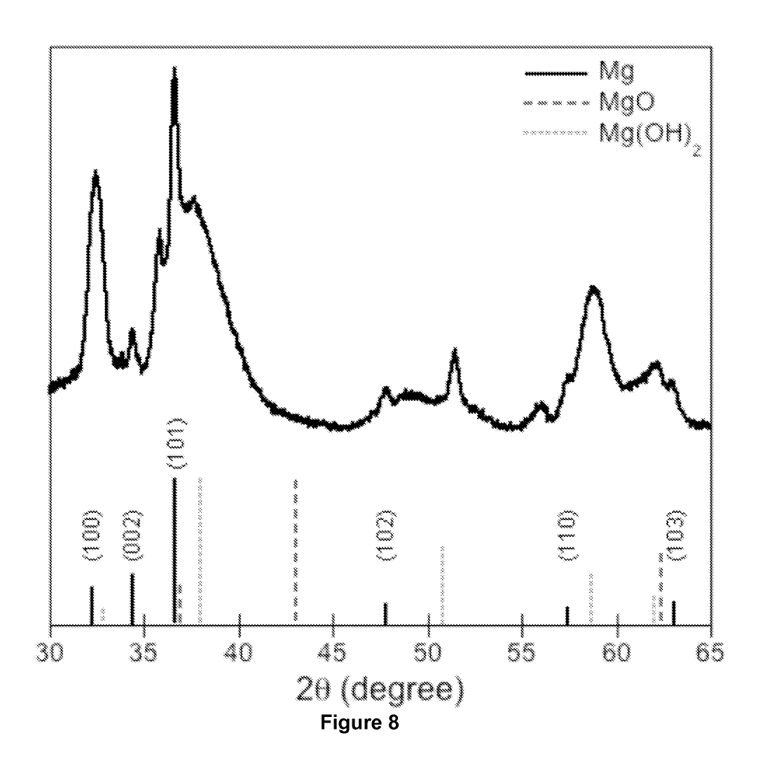

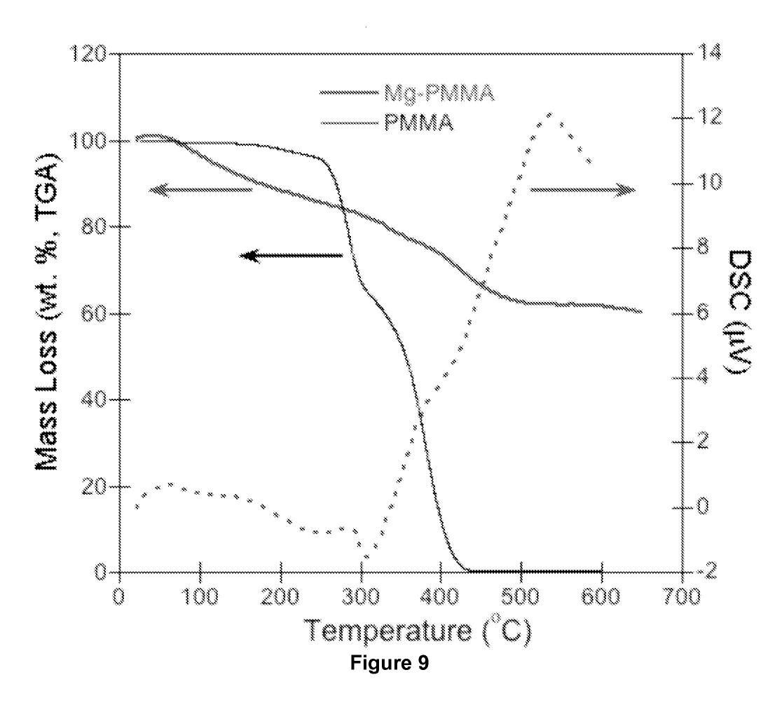

Transmission electron microscopy (TEM) micrographs showed that PMMA embedded Mg NCs have an approximately spherical morphology (FIG. 2a) with an average diameter of 4.9±2.1 nm and are well-distributed throughout the polymer phase with no evidence of agglomeration (FIGS. 6, 7). Although TEM analysis of >100 NCs from >12 different syntheses did not reveal larger NCs, the crystalline sizes of the Mg NCs determined from the XRD data are ca. 15±2 nm (Table 1), which suggests the possibility of either a bimodal distribution of Mg NCs (˜5 nm and ˜15 nm) or agglomeration, although neither of these has been observed via microscopy. FIG. 2b shows an atomic-resolution image of a particle along the [0001] direction which shows evidence of defects in the crystal lattice. Digital diffractograms obtained from TEM images taken of Mg NCs/PMMA composites exposed to air for 2 weeks remarkably display diffraction only from hexagonal crystalline magnesium (FIG. 2c); there is no evidence for detectable amounts of a magnesium oxide layer. X-ray diffraction (XRD) patterns (FIG. 2d) of the Mg NCs/PMMA composite taken immediately after synthesis, and after 3 days of air exposure at room temperature, display diffraction peaks of single-phase hexagonal magnesium and exceptionally minute intensity from peaks characteristic of MgO²⁰ and Mg(OH)₂, indicating impressive air stability against oxidation. Similar results are obtained for Mg NCs/PMMA composites taken after 120 days of air exposure at room temperature. This synthetic strategy was verified by embedding these Mg NCs in other organic materials such as hexadecylamine for comparison, and the resulting XRD spectra indicate immediate oxidation (FIG. 8). Thermogravimetric analysis of the Mg NCs/PMMA composites indicates that 61% of the total nanocomposite weight is hydrogen storage active material (FIG. 9).

TABLE 1
Determination of X-ray diffraction Mg NC diameter using the
Debye-Scherrer equation: Diameter = 0.9 λ/β*cosθ, where λ is the
wavelength of the X-ray (0.154 nm) and β is the full width at half
maximum of the diffraction peak. Four samples were examined at 3
separate indices, as listed below. The average diameter determined by
XRD was 15 ± 2 nm (1 standard deviation).

| Sample # | Index | 2θ (degree) | β (degree) | Diameter (nm) |
|---|---|---|---|---|
| 1 | (100) | 32.20 | 0.4861 | 17.0 |
| | (002) | 34.50 | 0.4538 | 18.3 |
| | (101) | 36.74 | 0.4213 | 19.9 |
| 2 | (100) | 32.19 | 0.5000 | 16.5 |
| | (002) | 34.44 | 0.6389 | 13.0 |
| | (101) | 36.64 | 0.6111 | 13.7 |
| 3 | (100) | 32.22 | 0.5000 | 16.5 |
| | (002) | 34.42 | 0.5833 | 14.3 |
| | (101) | 36.64 | 0.5834 | 14.3 |
| 4 | (100) | 32.39 | 0.5834 | 14.2 |
| | (002) | 34.53 | 0.6611 | 12.6 |
| | (101) | 36.79 | 0.6222 | 13.5 |

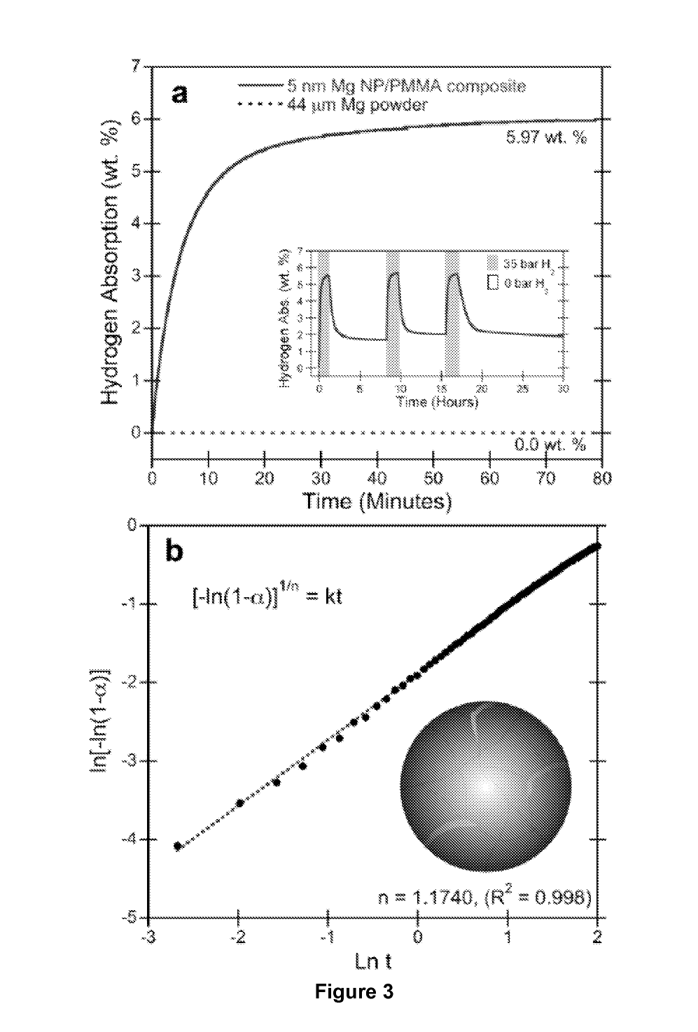

The hydrogen absorption capacity for Mg NCs/PMMA composites was measured in relation to a known reference material, bulk Mg (44 μm), using a Sieverts PCT-Pro at 35 bar H₂ and 200° C. (FIG. 3a). The bulk Mg shows no weight increase upon hydrogen exposure, indicating a lack of MgH₂ formation. However, the Mg NCs/PMMA composites display a sharp weight increase upon hydrogen exposure, with a steep slope of hydrogenation occurring during the first 6 minutes, which plateaus off to constant mass in <30 mins. The differences in slope between the first 6 minutes and the remainder of the absorption curve are attributed to a change in the rate-limiting mechanism for hydrogen uptake.²¹ It was found that the hydrogen absorption capacity of the Mg NCs/PMMA composite was well-preserved through three absorption/desorption cycles (FIG. 3a inset), however slightly decreased dehydriding kinetics were observed after the 3rd cycle as evinced from the decreased slope of descent. This marginal degradation is likely due to material fatigue owing to relaxation of structural defects, but more detailed investigation is necessary. From the measured absorption isotherm, a calculated hydrogen absorption capacity value of 5.97 wt. % Mg (˜4 wt % in overall composite mass) is reported. Thus, these composites absorb 78.6% of the theoretical value of magnesium. The calculated experimental volumetric hydrogen capacity of the composites is 55 g/L (the theoretical capacity for the Mg NCs/PMMA composites is 70 g/L). This value exceeds the volumetric capacity of compressed hydrogen (10,000 psi, 30 g/L) by 180%, demonstrating that Mg NCs/PMMA composites provide a viable storage alternative to gas tanks. Comparatively bulk Mg (<37 μm) absorbs only ±2% of the theoretical hydrogen absorption value within 10 minutes at 35 bar, and requires prohibitively high temperatures (400° C.) to do so.²²

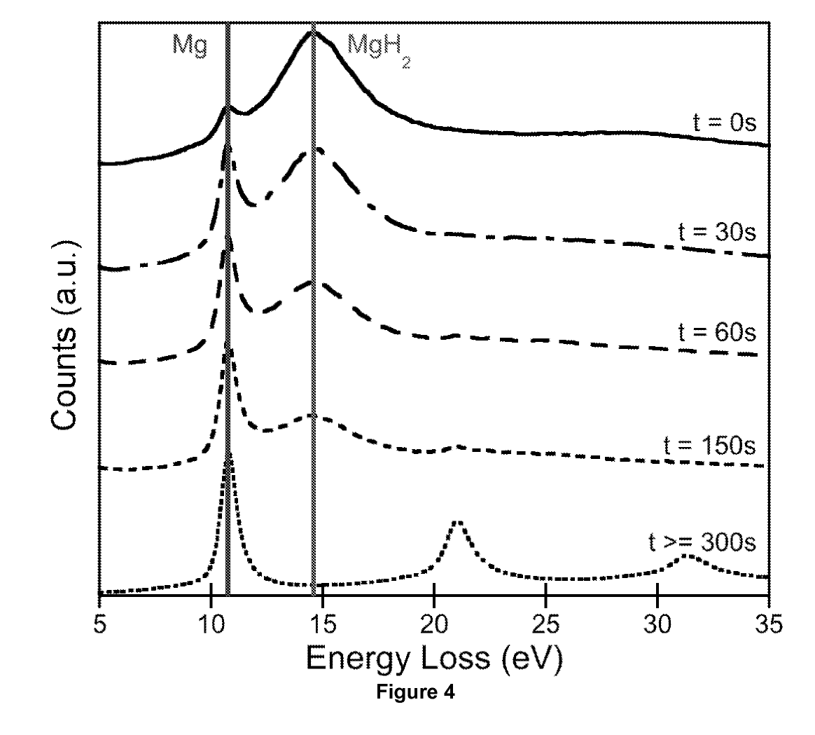

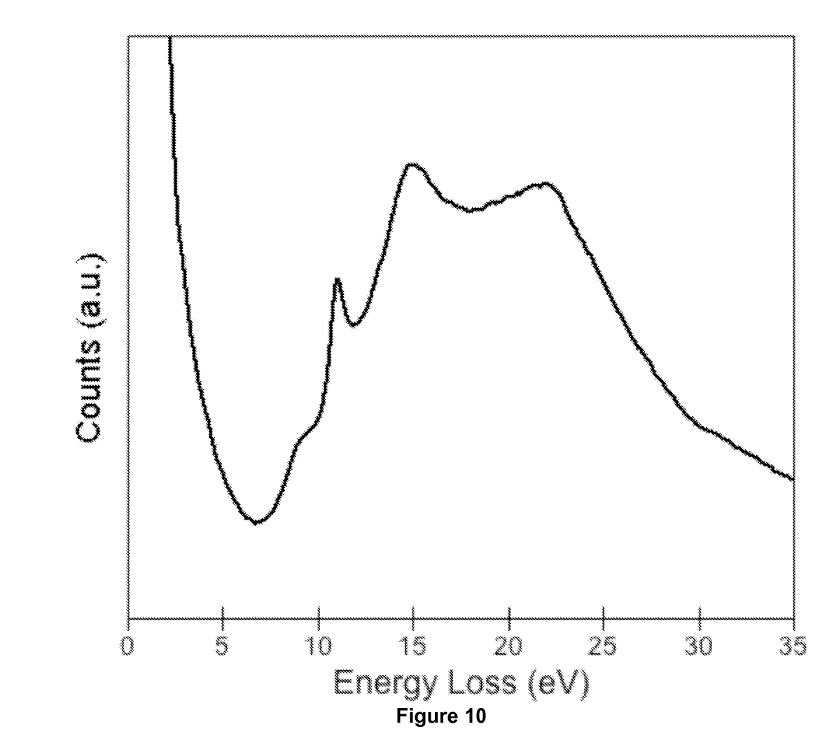

To verify that hydrogen uptake in this Mg NCs/PMMA composite is due to metalhydride formation and not polymer adsorption, time-resolved low-loss electron energy loss spectroscopy (EELS) was performed on MgH₂ NCs/PMMA composites using a monochromated and aberration-corrected transmission electron microscope at 80 kV.²³ FIG. 4 displays the time resolved and normalized EELS spectrum of the MgH₂—PMMA composites. At time 0 s, two distinct, intense EELS peaks are observed at 10.5 and 14.6 eV, corresponding to the co-existence of pure Mg and MgH₂, respectively.²⁴ As the exposure time to the electron beam increases, the relative intensity of the Mg peak increases in relation to the intensity of the MgH₂ peak. The intensity ratio (IMgH₂/IMg) reduces from 2.04 to 0 during the 5 minutes of beam exposure owing to hydrogen loss from the hydride phase. Notably, the presence of the characteristic MgO peak at ca. 22.3 eV (FIG. 10) was not observed in the sample, further evidence supporting the remarkable oxidative stability of these composites.

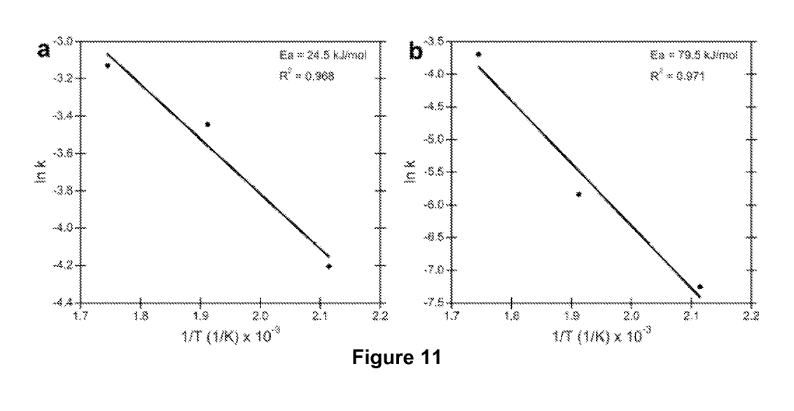

Theoretical calculations indicate that Mg NPs can exhibit more favorable thermodynamics (i.e. lower enthalpies for hydride formation) than bulk Mg due to the destabilization of MgH₂ formation.^{6,7} Additionally, it is known that the chemical reactivity of Mg NPs positively correlates to the large metal surface area and the short diffusion path of hydrogen.²⁵ We postulate that nanostructuring of magnesium in the nanocomposites obviates the need for expensive heavy-metal catalysts by reducing the activation energy for absorption and release of hydrogen.¹¹ To assess this, we have determined an activation energy (Ea) from analysis of the absorption and release of hydrogen at three different temperatures (FIG. 11). We measure Ea values of 25 and 79 kJ/mol for absorption and desorption, respectively, which are comparable to, and in some cases lower than, those obtained from similar materials requiring heavy-metal catalysts.²⁶

Hydrogen absorption in a crystalline solid can either occur due to isotropic diffusion and random nucleation, or preferential nucleation along certain favorable crystal axes. Further optimization of these materials requires a physical understanding of the mechanism of hydride formation in the nanocomposite, which can be obtained via modeling of the uptake kinetics. Here, experimental absorption data of the Mg NCs/PMMA composite materials was fitted with several basic empirical and theoretical kinetic models developed by Avrami,²⁷ which enable characterization of the mechanism and dimensionality of MgH₂ phase formation. Experimental data from the first 6 minutes of hydrogen absorption in the Mg NCs/PMMA composites was fit with the Johnson-Mehl-Avrami model (equation (1)):

[−ln(1−α)]1/n=kt (1)

where α is the hydrogenated fraction of Mg, k is the phase transformation constant, t is time, and n is the dimensionality of MgH₂ growth. This model assumes a constant interface velocity of MgH₂ formation.²¹

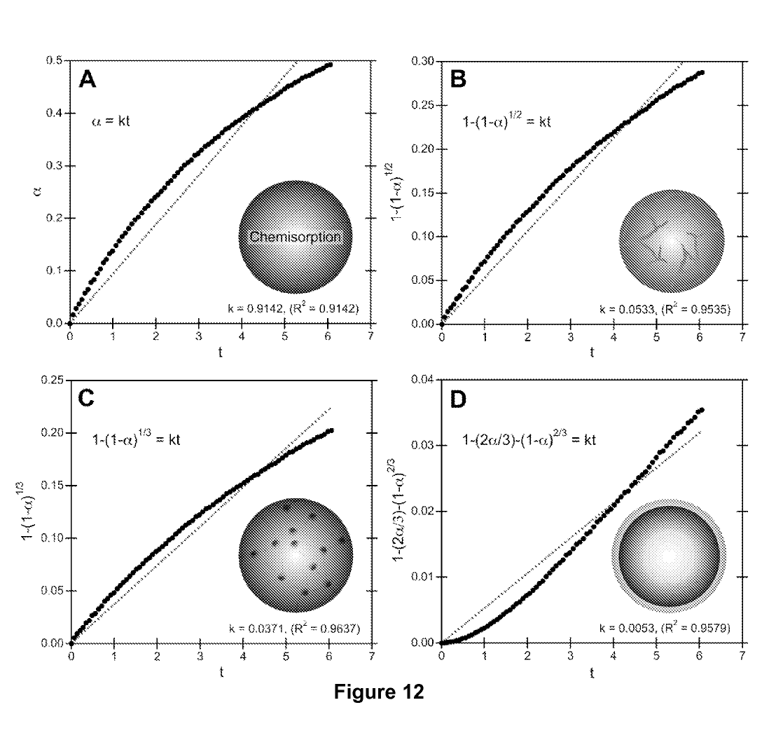

By using the dimensionality factor (n) in equation (1) as a fitting parameter, and solving for the best fit (R²) of the data, the dimensionality of the growth of the MgH₂ phase was determined to be 1.1740 (R²=0.998). There exist numerous growth and nucleation scenarios consistent with a value of n=1, including nucleation and growth along 1-D dislocation lines and thickening of cylinders, needles, and plates.²⁸ We posit that MgH² growth in the individual Mg nanocrystals in the composite occurs nearly 1-dimensionally along columnar defects as they are exposed to H₂ gas (FIG. 3b), as consistent with the HRTEM observations (FIG. 2b), although other possible scenarios cannot be excluded at present. To exclude other competing mechanisms, the MgH₂ hydrogen absorption data was fit to additional Johnson-Mehl-Avrami models of varying dimensionality and mechanism (Eqs 2-4 in Table 2). These additional Johnson-Mehl-Avrami models (FIG. 12) had comparatively poor fits (R²=0.914-0.964) in comparison to the growth model of equation (1), supporting the hypothesis that hydrogen absorption in the Mg NCs/PMMA composites occurs via 1-dimensional growth. This novel, 1-D growth mechanism is also consistent with our measurement of rapid kinetics in the Mg NCs, as hydrogen diffusion through Mg hydride layers is many orders of magnitude slower than the diffusion of hydrogen atoms through lattice vacancies.^{25,29} Analysis of high-resolution TEM images of the composites provides: evidence for the existence of defects in the Mg NCs (FIG. 2b). It is known that hydrogen atoms can more easily diffuse along 1-D line defects which can act as hydrogen trap sites. Thus, we posit that in Mg NCs/PMMA composites, hydrogen atoms rapidly nucleate and accumulate along these defects and form a metal hydride layer in one dimension followed by subsequent growth and thickening from the pure metallic core. This conclusion also corroborates recent published results on hydride growth in MgH₂ fibers.¹⁹

TABLE 2
Johnson-Mehl-Avrami models with description (M. Avrami, J. Chem.
Phys. 7, 1103 (1939); M. Avrami, J. Chem. Phys. 9, 177 (1941)).

| Model equation | | Description |
|---|---|---|
| (2) | α = kt | Surface controlled (chemisorption) |
| (3) | 1 − [1 − α]^{1/n} = kt | Contracting volume, n-dimensional |
| | | growth with constant interface velocity |
| (4) | $1 - ( \frac{2 α}{3} ) - {( 1 - α )}^{2 / 3} = kt$ | Contracting volume, 3-dimensional growth diffusion controlled with decreasing interface velocity |

In summary, we have developed a new, simple method to synthesize air-stable crystalline Mg NCs/PMMA composites by encapsulation in a polymer with selective gas permeability, protecting the NCs from O₂ and H₂O. The Mg NCs/PMMA composites impressively showed no oxidation in HRTEM diffractograms after 2 weeks of air exposure. Rapid uptake (<30 mins at 200° C.) of hydrogen was achieved with a high capacity (˜6 wt. % in Mg, ˜4% overall) in the absence of heavy-metal catalysts, demonstrating a volumetric capacity (50 g/L) greater than that of compressed H₂ gas. Theoretical modeling of the experimental data with a Johnson-Mehl-Avrami model indicates that hydrogenation of Mg NCs proceeds through 1-dimensional growth, which can occur along line defects in the Mg NCs, as observed via HRTEM. Generally, this approach of synthesizing nanosized air sensitive metal nanocrystals protected in a gas-selective polymer provides new opportunities in low-cost high capacity hydrogen storage media, batteries, and fuel cells.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What we claim is:

1. A composition capable of storing hydrogen comprising a nanoparticle (NP) and a polymer, wherein the NP is essentially embedded in the polymer and the polymer is essentially not permeable to O₂ and H₂O.

2. The composition of claim 1, wherein the NP is a Mg nanocrystal (NC) or Ti NC, nanotube, nanorod, or nanowire.

3. The composition of claim 1, wherein the size of the NP is from about 1 nm to about 10 nm in diameter for the longest or shortest linear dimension.

4. The composition of claim 3, wherein the size of the NP is from about 2.8 nm or 3 nm to about 7 nm in diameter for the longest or shortest linear dimension.

5. The composition of claim 4, wherein the size of the NP is from about 4 nm to about 6 nm in diameter for the longest or shortest linear dimension.

6. The composition of claim 1, wherein the NP further comprising Ti.

7. The composition of claim 1, wherein the polymer has a ratio of permeability for H₂ to permeability for O₂ of equal to or higher than 5.

8. The composition of claim 7, wherein the polymer has a ratio of permeability for H₂ to permeability for O₂ of equal to or higher than 10.

9. The composition of claim 8, wherein the polymer has a ratio of permeability for H₂ to permeability for O₂ of equal to or higher than 20.

10. The composition of claim 9, wherein the polymer has a ratio of permeability for H₂ to permeability for O₂ of equal to or higher than 30.

11. The composition of claim 10, wherein the polymer has a ratio of permeability for H₂ to permeability for O₂ of equal to or higher than 40.

12. The composition of claim 1, wherein the polymer is a polyacrylate, silicone, glass, or sulfonate.

13. The composition of claim 12, wherein the polymer is a poly(alkyl methacrylate), poly(methyl methacrylate) (PMMA) or poly(methyl acrylate) (PMA).

14. The composition of claim 1, wherein the composition comprises a NP-PMMA composite.

15. The composition of claim 1, wherein the composition is capable of absorbing equal to or more than about 4 wt. % of molecular hydrogen.

16. The composition of claim 15, wherein the composition is capable of absorbing equal to or more than about 5 wt. % of molecular hydrogen.

17. The composition of claim 16, wherein the composition is capable of absorbing equal to or more than about 6 wt. % of molecular hydrogen.

18. The composition of claim 1, wherein the composition is capable of separating any or essentially all absorbed molecular hydrogen when the temperature of the composition is equal to or more than about 200° C.

19. A method of storing hydrogen comprising: (a) providing the composition of claim 1, (b) contacting a molecular hydrogen with the composition, and (c) increasing the temperature of the composition such that the molecular hydrogen is separates from the composition.

20. The method of claim 19, wherein step (c) comprises heating the composition to a temperature of equal to or more than about 200° C.
